(19) United States
(12) Patent Application Publication
(10) Pub. No.: US 2015/0035934 A1
(43) Pub. Date: Feb. 5, 2015

(54) VIDEO MESSAGE RECORD TERMINAL, VIDEO MESSAGE TRANSMITTING SERVER AND METHOD FOR LEAVING VIDEO MESSAGE

(71) Applicant: HON HAI PRECISION INDUSTRY CO., LTD., New Taipei (TW)

(72) Inventors: MEI-JU CHEN, New Taipei (TW); HAN-FANG TU, New Taipei (TW); KUAN-JUNG CHIU, New Taipei (TW)

(21) Appl. No.: 14/448,410

(22) Filed: Jul. 31, 2014

(30) Foreign Application Priority Data
Aug. 2, 2013 (TW) 102127787

(51) Int. Cl. H04N 7/14; H04N 7/15

(52) U.S. Cl. CPC H04N 7/148; H04N 7/15
USPC 348/14.02

(57) ABSTRACT

A terminal for recording video message includes an audio capture unit, an image capture unit, a storage unit and a processing unit. The audio capture unit captures audio data. The image capture unit captures image data. The image data is associated with the captured audio data. The storage unit stores identities of recipients. The processing unit determines one or more recipients of a video message. A video message is created and the relationships between the one or more determined recipients and the created message are established. The created message and the established relationships are transmitted to an apparatus for broadcasting the video message.

### FIELD

The subject matter herein generally relates to video messages, and more particularly, to a terminal for recording video messages, a server for transmitting video messages, and a method for leaving video messages.

### BACKGROUND

People communicate with each other by telephone calls, text messages or emails. However, these ways can't supply a real-time video to each other when they are communicating. With the development of video and mobile communication technology, video calls and video messages have become popular as they can supply a real-time video to each other when they are communicating.

### BRIEF DESCRIPTION OF THE DRAWINGS

Implementations of the present technology will now be described, by way of example only, with reference to the attached figures.

FIG. 1 is a block diagram of one embodiment of a video message system.

FIG. 2 is a block diagram of the terminal of FIG. 1.

FIG. 3 is a block diagram of the server of FIG. 1.

FIG. 4 is flowchart of one embodiment of a method for leaving video message.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “module,” and “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like. The term “video,” when utilized, means “audio data and image data”.

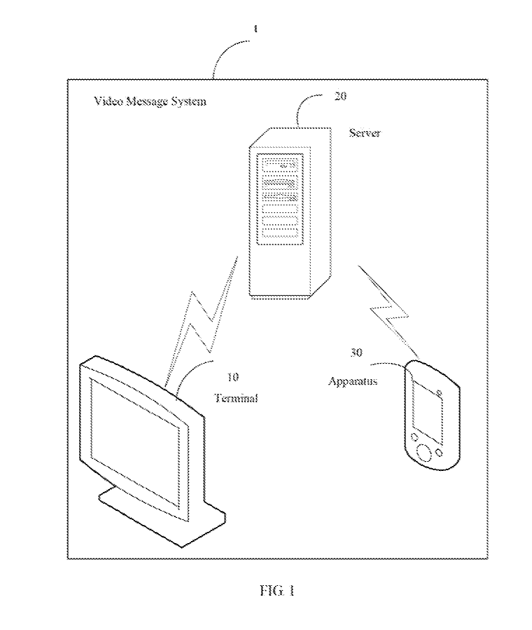

FIG. 1 illustrates a video message system 1. The video message system 1 can include a terminal 10 for recording video messages, an apparatus 30 for broadcasting video messages and a server 20. The terminal 10 and the apparatus 30 are connected to the server 20 via network. The server 20 can transmit video messages from the terminal 10 to the apparatus 30. The terminal 10 and the apparatus 30 can be televisions, telephones or tablets that have functions of recording video messages and broadcasting video messages. In an embodiment, the terminal 10 and the apparatus 30 can be the same device.

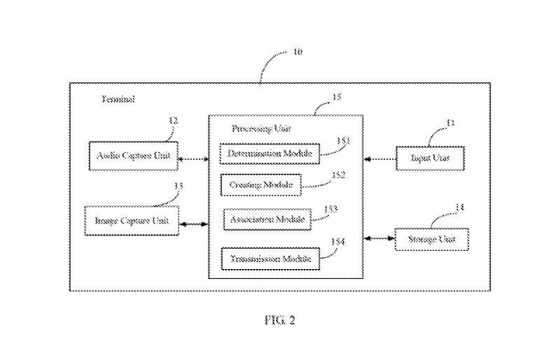

FIG. 2 illustrates block modules of the terminal 10. The terminal 10 can include an input unit 11, an audio capture unit 12, an image capture unit 13, a storage unit 14, and a processing unit 15.

The input unit 11 can generate request signals in response to input operations of a user, for example, a first request signal for determining the recipients of video messages, a second request signal for creating video messages, a third request signal for transmitting video messages, and so on.

When a user wants to leave video messages to one or more recipients, he or she operates the input unit 11 to control the audio capture unit 12 to capture audio data of the user, and control the image capture unit 13 to capture image data of the user. The captured image data is associated with the captured audio data.

The storage unit 14 can store identities of message recipients. In one embodiment, the identities of message recipients can include names of the recipients and pictures symbolizing the recipients. In an alternative embodiment, the identities of the recipients can include names of the recipients or pictures symbolizing the recipients.

The processing unit 15 can include a determination module 151, a creating module 152, an association module 153, and a transmission module 154.

The determination module 151 can determine one or more recipients of a video message. In at least one embodiment, the determination module 151 determines one or more recipients of a video message in response to an input operation of a user. For example, when the process of creating a message is over or started, the terminal 10 displays the stored pictures or names of contact persons of the user, then the user can select one or more pictures or names. The determination module 151 determines the person whose picture or name is selected is one of the recipients of the video message.

The creating module 152 can create a video message. The created video message includes audio data and image data. In at least one embodiment, the creating module 152 creates a video message utilizing the audio data captured by the audio capture unit 12 and the image data captured by the image capture unit 13. In an alternative embodiment, the creating module 152 stores the created video message in the storage unit 14.

The association module 153 can establish relationships between the one or more determined recipients and the created video message. In an alternative embodiment, the association module 153 further stores the established relationships in the storage unit 14. The transmission module 154 transmits the video message and the relationships associated with the video message to the server 20.

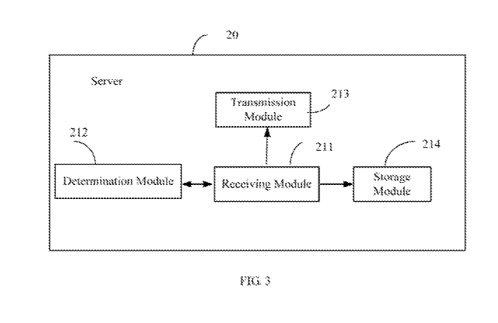

FIG. 3 illustrates block modules of the server 20. The server 20 can include a receiver module 211, a determination module 212, a transmission module 213, and a storage module 214.

The receiver module 211 can receive the video message and the relationships transmitted from the terminal 10. When the receiver module 211 receives the video message and the relationships, the determination module 212 determines whether one or more recipients of the received message are online. When all recipients of the received message are offline, the storage module 215 can store the received video messages. When the determination module 212 determines that one or more recipients of the received message are online, the transmission module 213 transmits the video message to the one or more online recipients. In the embodiment, the recipient of the video message may be an owner or other users of the apparatus 30, therefore, an apparatus 30 represents one or more recipients of the video message, and the transmission module 213 transmits the message to the apparatus 30 that represents one or more online recipients of the video message, and controls the apparatus 30 to broadcast the received video message. Thus, the user and the recipients can make a face-to-face communication.

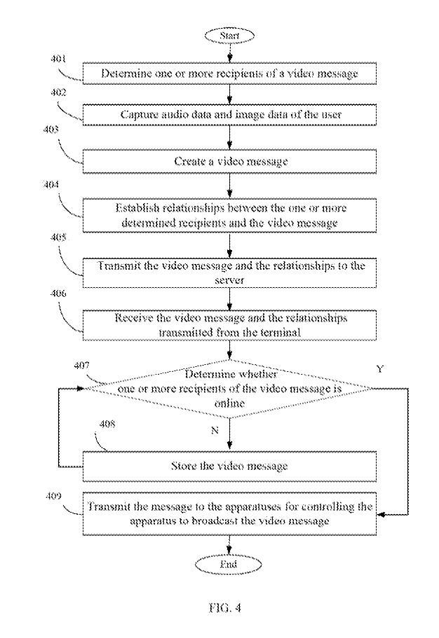

FIG. 4 illustrates a flowchart of a method for leaving a video message in accordance with an example embodiment. The example method is provided by way of example, as there are a variety of ways to carry out the method. The method described below can be carried out using the configurations illustrated in FIGS. 2-3, for example, and various elements of these figures are referenced in explaining example method. Each block shown in FIG. 4 represents one or more processes, methods or subroutines, carried out in the exemplary method. Additionally, the illustrated order of blocks is by example only and the order of the blocks can change according to the present disclosure. The exemplary method can begin at block 401.

At block 401, the determination module determines one or more recipients of a video message. In at least one embodiment, the determination module determines the one or more recipients of a video message in response to a user input operation.

At block 402, the audio capture unit captures audio data of the user and the image capture unit captures image data of the user in response to an input operation of the user. In the embodiment, the captured image data is associated with the captured audio data.

At block 403, the creating module creates a video message. The created video message includes audio data and image data. In at least one embodiment, the creating module creates the video message utilizing the audio data captured by the audio capture unit and the image data captured by the image capture unit.

At block 404, the association module establishes relationships between the one or more determined recipients and the video message. In an alternative embodiment, the association module stores the relationships in the storage unit.

At block 405, the transmission module transmits the video message and the relationships associated with the video message to the server.

At block 406, the receiver module receives the video message and relationships transmitted from the terminal.

At block 407, the determination module determines whether one or more recipients of the video message is online. If all of the recipients of the video message are offline, the process goes to block 408; if one or more recipients of the video message are online, the process goes to block 409.

At block 408, the storage module stores the video message and the relationships associated with the video message, then goes to block 407.

At block 409, the transmission module transmits the video message to the apparatuses that represent one or more online recipients of the video message for controlling the apparatus to broadcast the video message.

The embodiments shown and described above are only examples. Many details are often found in the art such as the other features of a terminal and an apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What claimed is:

1. A terminal comprising:
an audio capture unit for capturing audio data of a user in response to the user operation;
an image capture unit for capturing image data of the user in response to the user operation, the captured image data being associated with the captured audio data to form a video message;
a storage unit for storing identities of a plurality of recipients; and
a processing unit comprising:
a determination module configured for determining one or more recipients of a video message to be created, the one or more determined recipients being selected from the stored recipients;
a creating module configured for creating a video message, the created video message comprising the captured audio data and the captured image data;
an association module configured for establishing relationships between the one or more determined recipients and the created video message;
a transmission module configured for transmitting the video message and the relationships associated with the video message to the apparatus for controlling the apparatus to broadcast the video message.

2. The terminal as claimed in claim 1, wherein the association module is also configured for storing the created video message and the established relationships in the storage unit.

3. The terminal as claimed in claim 2, wherein the transmission module is also configured for transmitting the created video message and the established relationships stored in the storage unit to the apparatus.

4. The terminal as claimed in claim 1, wherein the determination module also determines one or more recipients of the video message in response to input operations of the user.

5. The terminal as claimed in claim 1, wherein the identities of each of recipients comprise names of the recipients or images symbolizing the recipients.

6. A server for transmitting video messages, communicating with a terminal and an apparatus, the server comprising:
a receiving module configured for receiving a video message transmitted from the terminal, the video message being associated with one or more recipients and comprising identities of the associated one or more recipients;
a determination module configured for determining whether one or more recipients of the received video message are online; and
a transmission module configured for transmitting the video message to the apparatus associated with the online recipient of the video message for controlling the apparatus to broadcast the video message when one or more recipient are online.

7. The server as claimed in claim 6, wherein the server further comprises a storage module for storing the received video message when all of the recipients of the video message are offline.

8. The server as claimed in claim 6, wherein the identities of each of recipients comprise names of the recipients or images symbolized the recipients.

9. A method for leaving video messages, comprising:
determining one or more recipients of a video message;
capturing audio data and image data of a user in response to an input operation of the user, the image data being associated with the audio data;
creating a video message, the video message comprising the captured audio data and the captured image data;
establishing relationships between the one or more determined recipients and the created video message;
generating a request signal; and
transmitting the created video message, the established relationships, and the request signal to a server, the request signal requesting the server to determine whether one or more recipients of the received video message are online and requesting the server to transmit the video message to an apparatus for controlling the apparatus to broadcast the video message when one or more recipients of the video message are online, the apparatus being associated with the one or more online recipients.

10. The method as claimed in claim 9, wherein the request signal also requests to store the video message in the server when all of the recipients are offline.

11. The method as claimed in claim 9, wherein determining one or more recipients of the video message in response to input operations of the user.

12. The method as claimed in claim 9, wherein the request signal also requests to store the created video messages and the established relationships in the server.
